(19) United States
(12) Patent Application Publication
(10) Pub. No.: US 2025/0053899 A1
(43) Pub. Date: Feb. 13, 2025

(54) Computer-Implemented Methods and Computer Systems for Artificial Intelligence (AI) Based Automated Provision of Management Consulting

(71) Applicant: Chase Hughes, Crawfordsville, IN (US)

(72) Inventor: Chase Hughes, Crawfordsville, IN (US)

(73) Assignee: Chase Hughes, Crawfordsville, IN (US)

(21) Appl. No.: 18/581,439

(22) Filed: Feb. 20, 2024

Related U.S. Application Data
(60) Provisional application No. 63/518,334, filed on Aug. 9, 2023.

(51) Int. Cl. G06Q 10/0631; G06Q 10/0639

(52) U.S. Cl. CPC G06Q 10/063118; G06Q 10/06393

(57) ABSTRACT

Embodiments of the present invention provide a computer-implemented method for Artificial Intelligence (AI) based provision of management consulting. The computer-implemented method includes dividing the provision of management consulting into a plurality of tasks, the plurality of tasks defined as a plurality of respective workflows. Furthermore, the computer-implemented method includes assigning a plurality of Artificial Intelligence (AI) agents to the plurality of tasks with each one of the plurality of tasks assigned at least one AI agent. The computer-implemented method further includes providing the plurality of AI agents with characteristic reference data obtained from a plurality of data sources. Furthermore, the computer-implemented method includes providing a plurality of interfaces to the plurality of AI agents for enabling exchanges of data amongst the plurality of AI agents. The computer-implemented method also includes generating a plurality of deliverables in a plurality of user-readable formats, the plurality of deliverables constituting management consulting.

### TECHNICAL FIELD

The present invention relates to Artificial Intelligence (AI) based automation of business processes. More specifically, the present invention relates to the automated provision of management consulting and planning documentation by leveraging several Artificial Intelligence (AI) agents interacting with each other.

### BACKGROUND ART

Entrepreneurs and businessmen often solicit the services of consulting firms to kick-start, run, expand (by adding new verticals), and monetize their businesses. Such services include (1) management consulting planning including corporate strategy, business-unit strategy, go-to-market strategy, and digital strategy, (2) operations structuring such as organizational design, process improvement, cost reduction, and supply chain management, (3) financial consulting such as enabling mergers and acquisitions, corporate finance, risk management, and financial modeling, (4) marketing and sales management such as marketing strategy, sales effectiveness, Customer Relationship Management (CRM), and pricing, and (5) other services such as leadership and organization, sustainability, technology and innovation, and people and organization.

However, such services have some key limitations. The costs of hiring consulting firms are often prohibitively expensive for many businesses, especially smaller companies or startups. The typical model of parachuting in external consultants can face challenges in implementing changes, as organizational inertia and resistance frequently hamper progress. Employees accustomed to legacy processes are slow to adopt radically new ways of operating. Further, the siloed nature of consulting projects often fails to translate into enterprise-wide transformation. Thus, while management consulting services provide valuable strategic and operational advice, the high costs, slow implementation cycles, and piecemeal approach leave significant room for improvement in realizing the full benefits for clients. There remains an unmet need in the art for solutions that can provide affordable, rapidly implemented, and organizationally integrated consulting.

However, such services are provided by a handful of organizations specialized in the business consulting space and generally involve large amounts of costs to be paid by the business owners. Such costs are not always affordable to many small businesses and start-ups that have not managed to successfully arrange for sufficient funding through their investors. Moreover, as per industry practices, generally, a group of consultants from the consulting firms are assigned to a client business with whom they have to introduce structural and operational changes. Implementing such structural and operational changes in an organization that has been operating conventionally for a fairly long period can be arduous. There is always an inertia amongst personnel, operating in a certain manner for a long duration, to radical changes, and therefore successful implementation of the new business strategies relies heavily on the interpersonal skills of the group of consultants deputed to the concerned organization. Moreover, due to the involvement of so many individual human resources, the process of transition from one set of practices and business processes to another set of practices and business processes can be relatively slow and time-consuming, thereby adding to the overheads of the business or the organization soliciting such services.

Modern innovations in the field of Artificial Intelligence (AI) based agents have allowed at least some of the aspects of management consulting planning and implementation, such as financial forecasting, to be automated. However, the coverage of such solutions is often limited to a handful of aspects of management consulting planning. Moreover, deliverables received from such solutions are not always directly comprehensible to decision-makers, and interpreters and liaisons are still required to translate the deliverables generated by such solutions into forms of information that can enable executable decisions to be made. Moreover, most of the AI agents are based on Large Language Model (LLM) agents which have matured quite rapidly in the past few years but still are essentially limited to processing text-based data. LLM agents that can comprehensively integrate and interpret numerical data and audio-visual information such as GANTT charts are far from maturity.

Therefore, there is a need in the art for computer-implemented methods and computer systems for the automated generation of management consulting that are fast, efficient, and easier to implement through seamless integration with current practices and processes of a business looking to kick-start, expand, or undergo restructuring.

### OBJECTS OF THE INVENTION

Some of the objects of the invention are as follows:

An object of the present invention is to provide computer-implemented methods and computer systems that leverage interactions of several Artificial Intelligence (AI) agents to generate documentation related to several different aspects of management consulting.

Another object of the present invention is to provide computer-implemented methods and computer systems that can access information and databases that are available through several different sources during the provision of management consulting.

Another object of the present invention is to provide computer-implemented methods and computer systems that allow integration of currently available and widely implemented business process management solutions as data sources for the training of AI agents.

Another object of the present invention is to provide computer-implemented methods and computer systems that allow users to upload data through sources such as the Internet or memory drives, where the uploaded data may then be used to train the AI agents and/or generate management consulting documentation.

Another object of the present invention is to provide computer-implemented methods and computer systems that allow the integration of custom-built coded features that are capable of addressing deficiencies of currently available AI agents.

Another object of the present invention is to provide computer-implemented methods and computer systems that can generate several business-strategy pertinent deliverables in user-readable formats enabling quick implementation of business decisions.

It is also an object of the present invention to provide computer-implemented methods and computer systems that allow the translation of information from one user-readable format to another user-readable format while maintaining the integrity and completeness of the information.

### SUMMARY OF THE INVENTION

According to a first aspect of the present invention, there is provided a computer-implemented method for Artificial Intelligence (AI) based provision of management consulting. The computer-implemented method includes dividing the provision of management consulting into a plurality of tasks, the plurality of tasks defined as a plurality of respective workflows. Furthermore, the computer-implemented method includes assigning a plurality of Artificial Intelligence (AI) agents to the plurality of tasks with each one of the plurality of tasks assigned at least one AI agent. The computer-implemented method further includes providing the plurality of AI agents with characteristic reference data obtained from a plurality of data sources. Furthermore, the computer-implemented method includes providing a plurality of interfaces to the plurality of AI agents for enabling exchanges of data amongst the plurality of AI agents. The computer-implemented method also includes generating a plurality of deliverables in a plurality of user-readable formats, the plurality of deliverables collectively constituting management consulting.

In one embodiment of the invention, the plurality of data sources comprises Enterprise Resource Planning (ERP) systems, Customer Relationship Management (CRM) systems, web servers, social media APIs, Electronic Content Management (ECM) systems, and public financial databases.

In one embodiment of the invention, the characteristic reference data comprises real-world examples in the form of case studies, financial statements, contracts, marketing materials, demographics, and interview transcripts.

In one embodiment of the invention, the computer-implemented method further includes receiving one or more user inputs from a user computing device through a user-proxy agent.

In one embodiment of the invention, one or more of the plurality of AI agents are further customized by training the one or more of the plurality of AI agents using fine-tuning techniques to fine-tune the one or more AI agents. In addition to fine-tuning, some AI agents are accountable for calling APIs within the multi-agent framework to collect information and distribute this to the other AI Agents.

In one embodiment of the invention, fine-tuning of the one or more AI agents includes identifying an AI agent from the plurality of AI agents, identifying a logic model for implementation of an inner monologue, implementing the inner monologue to the identified AI agent, and fine-tuning the inner monologue by distilling step-by-step method with manual intervention, and using a custom generated code segment.

In one embodiment of the invention, the characteristic reference data is provided in the forms of real-world examples and JavaScript Object Notation (JSON) data.

In one embodiment of the invention, the computer-implemented method further includes validating the plurality of deliverables using industry benchmark data as a reference.

In one embodiment of the invention, validating the plurality of deliverables further includes utilizing metrics including Key Performance Indicators (KPIs), benchmarking, regression analysis, gap analysis, and requirements traceability matrices.

In one embodiment of the invention, validating the plurality of deliverables further includes receiving user feedback through surveys, query responses, and explicit ratings.

In one embodiment of the invention, the computer-implemented method further includes modifying one or more of the plurality of tasks, the plurality of AI agents, and the characteristic reference data provided to the plurality of AI agents following the failure of the validation of the plurality of deliverables.

In one embodiment of the invention, the characteristic reference data is obtained automatically through a plurality of data extraction techniques.

In one embodiment of the invention, the plurality of data extraction techniques comprises the application of AI assistant retrieval agents, Retrieval-Augmented Generation (RAG) agents, web scraper agents, and visual web browsing agents.

In one embodiment of the invention, the plurality of data extraction techniques utilizes Optical Character Recognition (OCR), machine readings, text summarization, sentiment analysis, intent detection, Named Entity Recognition (NER), and Natural Language Processing (NLP).

In one embodiment of the invention, the plurality of data sources includes goods and/or services data, scraped data, market research, shot-term memory data, long-term memory data, automated information management services, and user uploads.

In one embodiment of the invention, the plurality of interfaces utilizes Application Programming Interfaces (APIs), data translation protocols, messaging formats, and object models to enable communication between the plurality of AI agents.

In one embodiment of the invention, the plurality of deliverables includes financial forecasting, dynamically generated and modifiable business plans, market research plans, operating plans, and expansion plans.

In one embodiment of the invention, the user-readable formats comprise a dashboard interface, spreadsheets, and rich text format.

In one embodiment of the invention, the computer-implemented method further includes translating data from one user-readable format to another user-readable format, of the plurality of user-readable formats.

In one embodiment of the invention, the computer-implemented method further includes adding predefined capabilities to the plurality of AI agents through custom-generated features coded in a compatible programming language.

According to a second aspect of the present invention, there is provided a computer system for Artificial Intelligence (AI) based provision of management consulting. The computer system includes a memory unit configured to store machine-readable instructions and a processor operably connected to the memory unit. The processor is configured to execute the machine-readable instructions, that when executed, enable the processor to divide the provision of management consulting into a plurality of tasks, the plurality of tasks defined as a plurality of respective workflows. Furthermore, the processor is enabled to assign a plurality of Artificial Intelligence (AI) agents to the plurality of tasks with each one of the plurality of tasks assigned at least one AI agent. The processor is further enabled to provide the plurality of AI agents with characteristic reference data obtained from a plurality of data sources. Furthermore, the processor is enabled to provide a plurality of interfaces to the plurality of AI agents for enabling exchanges of data amongst the plurality of AI agents. Also, the processor is enabled to generate a plurality of deliverables in a plurality of user-readable formats, the plurality of deliverables collectively constituting management consulting.

In one embodiment of the invention, the processor is further enabled to add predefined capabilities to the plurality of AI agents through custom-generated features coded in a compatible programming language.

In one embodiment of the invention, the processor is further enabled to customize one or more of the plurality of AI by training the one or more of the plurality of AI agents using fine-tuning techniques to fine-tune the one or more AI agents.

In one embodiment of the invention, for fine-tuning the one or more AI agents, the processor is further enabled to identify an AI agent from the plurality of AI agents, identify a logic model for implementation of an inner monologue, implement the inner monologue to the identified AI agent, and fine-tune the inner monologue by distilling step-by-step method with manual intervention, and using a custom generated code segment.

In one embodiment of the invention, the processor is further enabled to validate the plurality of deliverables using industry benchmark data as a reference.

In one embodiment of the invention, for validating the plurality of deliverables the processor is enabled to utilize metrics including Key Performance Indicators (KPIs), benchmarking, regression analysis, gap analysis, and requirements traceability matrices.

In one embodiment of the invention, for validating the plurality of deliverables the processor is further enabled to receive user feedback through surveys, query responses, and explicit ratings.

In one embodiment of the invention, the processor is further enabled to modify one or more of the plurality of tasks, the plurality of AI agents, and the characteristic reference data provided to the plurality of AI agents following the failure of the validation of the plurality of deliverables.

The present invention provides an end-to-end automated solution for generating customized management consulting deliverables that is more affordable, faster to implement, and easier to integrate than existing consulting approaches. By leveraging AI agents to automate workflows associated with tasks like financial modeling, business planning, and market research, the system significantly reduces the need for expensive human consultants. Tasks that previously required weeks of manual effort by teams of analysts can now be accomplished in days or hours. The automated deliverables can be generated on demand for a fraction of the cost of traditional consulting. Further, the system seamlessly integrates with a client's existing data and processes, ensuring a smooth transition rather than major disruptions. The modular architecture based on combining specialized AI agents allows customized solutions to be efficiently created for clients across industries and business models. The result is a management consulting solution that breaks down cost and speed barriers while enabling businesses to get expert advice that fits their unique needs and constraints.

In the context of the specification, the phrase “Sequential Query Language (SQL) database” refers to a relational database system for storing and managing structured data. The data is stored in the form of tables and the tables may be correlated with each other with relationships. The data stored in the SQL database may be searched, updated, filtered, and deleted using Sequential Query Language.

In the context of the specification, the phrase “vector database” refers to a system of storing data in the form of multi-dimensional numerical vectors, where each dimension represents a feature or a characteristic of the data. The vectors may be created using several techniques such as embedding which transforms complex data like text, images, or audio into numerical representations.

In the context of the specification, the phrase “Artificial Intelligence (AI) agent” refers to an autonomously acting computer program designed to perceive its environment, make decisions, and take actions to achieve a goal or a set of goals. The AI agents may further be equipped with data-gathering and learning (reinforcement learning, supervised learning, or unsupervised learning) capabilities.

In the context of the specification, the phrase “Large Learning Model (LLM) agent” refers to AI agents that use deep learning techniques to understand, generate, and manipulate human language. LLM agents are trained on relatively large amounts of data that allow them to identify complex patterns and relationships between words. LLM agents are generally equipped with several capabilities such as Natural Language Processing (NLP), Text Generation, Question Answering, Dialogue, and Summarization.

In the context of the specification, the phrase “user-proxy agent” refers to an LLM agent that acts as an interface between a user and several other LLM agents. The user-proxy agents are configured to perform several tasks such as clarifying ambiguous queries, contextualizing requests, and preparing data in response to queries received from the user. Furthermore, the user-proxy agents may interpret responses, run generated code, and present results to the user. Additionally, the user-proxy agents may receive feedback from the user to improve and personalize the results generated by the LLM agent.

In the context of the specification, the phrase “communication bus” refers to a software-implemented platform that allows two or more AI agents and other coded programs to communicate with each other exchanging data as per pre-defined data exchange protocols.

In the context of the specification, the phrase “few-shot learning” refers to the training of machine learning models from a limited amount of data. The few-shot learning may be approached in several ways such as meta-learning (allowing machine learning models to apply previous learning experiences to new tasks), data augmentation (artificially expanding available data by creating new examples based on existing ones), few-shot optimization (optimizing parameters specifically for the few-shot learning scenario). Few-shot learning techniques offer several advantages such as quick adoption of new tasks, reduced data requirements, improved performance on small datasets, and increased AI capabilities. More information on few-shot learning can be found in web publications arXiv: 2005.14165v4 and arXiv: 2203.04291v1 which are incorporated herein by reference, in their entirety.

In the context of the specification, the phrase “web scraper agent” also referred to as “web harvester” or “web data extractor” refers to a program used for automatically collecting and extracting data from websites and web pages. The web scraper agents work by mimicking human users, navigating websites, and extracting specific pieces of information based on predefined rules.

In the context of the specification, the phrase “AI assistant retrieval agent” refers to a software program tool that enhances the capabilities of an AI assistant by incorporating external knowledge sources beyond an inherent model of the AI assistant. The AI assistant retrieval agent acts as a bridge between the assistant and several external information sources, allowing the AI assistant to access and process information that resides outside the data on which the AI assistant was originally trained.

In the context of the specification, the phrase “Retrieval Augmented Generation (RAG) Agent” refers to a software program that combines retrieval of information from external knowledge sources such as text documents, websites, databases, or other structured information repositories and generation of text that is contextually relevant and informative, using the retrieved information as a basis or reference. More information on RAG agents can be found in web publications arXiv: 2005.11401v4 and arXiv: 2312.10997v4 which are incorporated herein by reference, in their entirety.

In the context of the specification, the phrase “visual web browsing agent” refers to a computer-implemented software that is capable of browsing through a large number of web pages and is capable of analyzing visual components, such as images, videos, and layouts, present in the web pages. In that regard, visual web browsing agents are capable of extracting visual elements and metadata from images and videos, identifying layouts and structures of web pages, and comparing visual elements of different pages to identify similarities and trends. More information on visual web browsing agents can be found in the web publication arXiv: 2305.11854v2 which is included herein by reference, in its entirety.

In the context of the specification, the phrase “JavaScript Object Notation (JSON)” refers to a format used for storing and exchanging structured data. It is based on JavaScript Object syntax but is language-independent. A JSON object can contain data represented as key-value pairs, nested objects, and arrays, and written as plain text.

In the context of the specification, the phrase “JSON library” refers to a collection of code designed to help program developers work with JSON data in their programs. The JSON libraries help the developers in parsing, generating, manipulating, validating, encoding, and decoding JSON data.

In the context of the specification, the phrase “Application Program Interface (API) server” refers to a software program or a computing device that hosts the software program that allows two or more applications to communicate with each other and exchange data and information. In that regard, the API server may be configured to perform several tasks such as (1) translating a request from a source application into a format that is compatible with a destination application, (2) security verification of the source application, for example, by checking IP address, geographical location, ports and channels used, authorization credentials of the source device, etc. (3) protocol verification of the message, such as verification of encryption methodology followed, (4) transmittal of the translated request to the destination application, (5) receive the requested data from the destination application, (6) translate the received data into a format that is compatible with the source application, and (7) transmit the data to the source application over a communication network.

In the context of the specification, the phrase “web server” refers to a computer system or an executable segment of machine-readable code that allows communication with client systems (such as a web browser or a standalone computer application) using the Hypertext Transfer Protocol (HTTP), a set of rules that define how web servers and clients exchange information. When a user types a URL into a web browser (acting as a client), the browser sends an HTTP request to the web server that hosts the website. The web server then processes the request and sends back an HTTP response that contains the requested content.

In the context of the specification, the term “firewall” refers to a network security device that monitors incoming and outgoing network traffic and decides whether to allow or block specific traffic based on a defined set of security rules. Firewalls establish a barrier between secured and controlled internal networks that can be trusted and untrusted outside networks, such as the Internet. The firewall can be implemented at a node level, referred to as a “host firewall” which protects every individual device from malicious content in incoming or outgoing traffic. Alternately, the firewall can be implemented at a network level, referred to as a “network firewall” which monitors traffic between two disparate networks, such as between a local intranet and the Internet.

In the context of the specification, the term “processor” refers to one or more of a microprocessor, a microcontroller, a general-purpose processor, a Field Programmable Gate Array (FPGA), a Graphics Processing Unit (GPU), a Neural Processing Unit (NPU), a Tensor Processing Unit (TPU), an Application Specific Integrated Circuit (ASIC), and the like.

In the context of the specification, the phrase “memory unit” refers to volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc.

In the context of the specification, the phrase “storage device” refers to a non-volatile storage memory such as EPROM, EEPROM, flash memory, or the like.

In the context of the specification, the phrase “communication interface” refers to a device or a module enabling direct connectivity via wires and connectors such as USB, HDMI, VGA, or wireless connectivity such as Bluetooth or Wi-Fi, or Local Area Network (LAN) or Wide Area Network (WAN) implemented through TCP/IP, IEEE 802.x, GSM, CDMA, LTE, or other equivalent protocols.

In the context of the specification, the phrase “communication network” refers to a group of several connected devices including computing devices (such as desktops, mobile handheld devices, tablet PCs, notebooks, etc.), local and remotely located servers (such as web servers, application servers, database servers, Application Program Interface (API) servers, load balancers, compute nodes, and the like), routers, antennas, modems, multiplexers, demultiplexers, and the like. In that regard, the aforementioned connected devices may be able to exchange data signals through wired and/or wireless means as per several combinations of several different communication protocols such as 802.11 (Wi-Fi), 802.3 (Ethernet), Bluetooth, NFC, ZigBee and 3GPP protocols such as HSPA, HSDPA, LTE, GSM, CDMA, WLL and the like.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 illustrates an example environment of devices in which several embodiments of the present invention may be implemented;

FIG. 2 illustrates an example multi-agent framework provided by a multi-agent framework server, in accordance with an embodiment of the present invention;

FIG. 3 illustrates a flow chart depicting a computer-implemented method for Artificial Intelligence (AI) based provision of management consulting, in accordance with an embodiment of the present invention;

FIG. 4A illustrates the assignment of a plurality of AI agents to a plurality of tasks involved in the provision of management consulting, in accordance with an embodiment of the present invention;

FIG. 4B illustrates a method for fine-tuning an AI agent of the plurality of AI agents, in accordance with an embodiment of the present invention;

FIG. 5A illustrates a pictorial representation of the AI-based provision of management consulting, in accordance with an embodiment of the present invention;

FIG. 5B illustrates a flowchart depicting an example implementation of the computer-implemented method for the AI-based provision of management consulting, in accordance with an embodiment of the present invention;

FIG. 6 illustrates an example dashboard Graphic User Interface (GUI) of a computer-implemented application implementing several embodiments of the present invention;

FIG. 7 illustrates an example GUI depicting several deliverables offered as a part of a business plan, by the computer-implemented application of FIG. 6;

FIG. 8 illustrates an example GUI depicting a questionnaire generated by a processor implementing one or more AI agents of the computer-implemented application of FIG. 6;

FIG. 9A illustrates an example GUI depicting several sections of a business plan as a deliverable generated by the processor implementing the computer-implemented application of FIG. 6;

FIG. 9B illustrates an example GUI depicting one or more ways in which the business plan of FIG. 9A may be edited by a user;

FIG. 10A illustrates an example GUI depicting a questionnaire generated by the processor implementing one or more AI agents for generating a financial plan as a deliverable by the computer-implemented application of FIG. 6;

FIG. 10B illustrates an example GUI depicting a comparison between historical financial data and a projected financial plan generated by the processor implementing the computer-implemented application of FIG. 6;

FIG. 11 illustrates an example GUI depicting documents uploaded by a user as the characteristic reference data to the computer-implemented application of FIG. 6;

FIG. 12 illustrates an example GUI depicting the integration of data available from third-party data management services, as the characteristic reference data to the computer-implemented application of FIG. 6; and

FIG. 13 illustrates an example GUI depicting the initiation of generation of an expansion plan for a given business entity, by the computer-implemented application of FIG. 6.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

The terms “a” and “an” herein do not denote a limitation of quantity, but rather denote the presence of at least one of the referenced items. The terms “having”, “comprising”, “including”, and variations thereof signify the presence of a component.

Embodiments of the present invention disclose computer-implemented methods and computer systems for Artificial Intelligence (AI) based provision of management consulting. The present invention involves dividing the process of generation management consulting into several tasks. Each one of the several tasks is assigned one or more pre-trained Artificial Intelligence (AI) agents. The AI agents in that regard may be widely available pre-generated and trained AI agents offered by third parties or may be custom-generated AI agents generated by the processor implementing a unique code or may be combinations of several modules of the other third-party AI agents.

It is further envisaged that the AI agents have been further customized by training them using fine-tuning techniques to enable them to be trained and implemented with minimal costs and lead times. The implementation of the AI agents helps automate the workflows associated with each one of the several tasks. Furthermore, characteristic reference data, in addition to the training data, is provided to the AI agents. In that regard, the characteristic reference data may include real-world examples in the form of case studies, financial statements, contracts, marketing materials, demographics, and interview transcripts. The characteristic reference data may be sourced from several online resources (such as web pages, government data, proprietary market research data, public financial databases, etc.) through several data extraction techniques. The data extraction techniques may include the use of AI assistant retrieval agents, Retrieval-Augmented Generation (RAG) agents, web scraper agents, and visual web browsing agents. Moreover, for absorption of the characteristic reference data by the AI agents, the characteristic reference data may be provided as JavaScript Object Notation (JSON) objects and real-world examples.

The AI agents may further be provided interfaces in the form of APIs and data translation syntax so that they can exchange data received and generated amongst the AI agents. In that manner, an output of one AI agent may become an input for another AI agent, or two or more AI agents may act in a combined manner to generate desired deliverables. Wherever there may be a deficiency in the ability of an AI to handle one form of data or performance of one kind of task, that deficiency may be fulfilled by another AI or may be fulfilled by custom-generated code written using a compatible programming language such as Python. After all of the tasks of the management consulting have been completed, the data generated by the processor implementing the AI agents may be used by additional custom-generated code to generate documents in user-readable formats such as interactive and dynamic dashboards, spreadsheets, rich text format, etc. Moreover, translation and mapping functions may be defined to translate or convert the documents from one user-readable format (such as spreadsheet) to another user-readable format (such as rich text format).

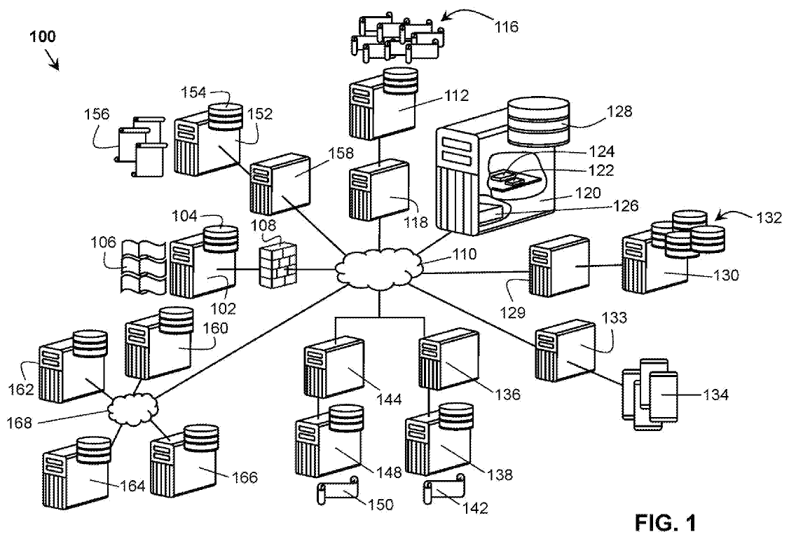

Several embodiments of the present invention will now be discussed in detail with reference to FIGS. 1-13.

FIG. 1 illustrates an example environment 100 of devices in which several embodiments of the present invention may be implemented. The environment 100 includes an Enterprise Data Management (EDM) server 102 configured to host an EDM application for the management of data concerning several organizations. Such data may include financial data such as investments, operational costs, company evaluation, payroll data, inventory stockpiles, accounting data such as purchases and sales, current liquidity, quarterly profits since the inception, values of shares, debentures, and other forms of bonds, etc. Some of the examples of EDM applications include Amazon Redshift, Ataccama ONE, Cloudera, Druva Phoenix, etc. The EDM server 102 is operably connected to an EDM storage device 104 that stores all the data in the form of EDM data files 106. The EDM server 102 is connected with a first communication network 110 through a firewall 108. The firewall 108 may be implemented as a network firewall, a host firewall, or combinations thereof.

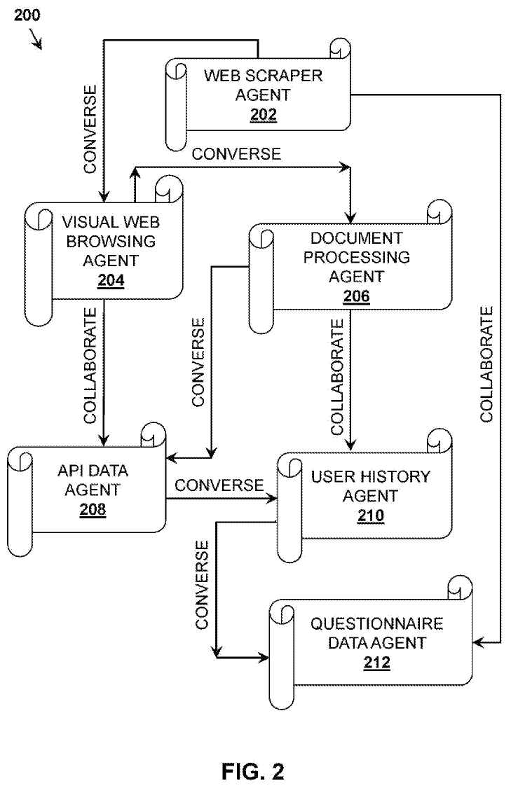

Further connected to the first communication network 110 is a multi-agent framework server 112. The multi-agent framework server 112 is configured to provide a multi-agent framework (See FIG. 2) by integrating several AI agents 116 collaborating to achieve rule-based tasks. An example of such a framework is Microsoft® Autogen. More information on Microsoft® Autogen can be found in the web publication arXiv: 2308.08155v2 which is included herein by reference, in its entirety. In that regard, the framework may provide interfaces, languages, and protocols through which several AI agents may be able to communicate with each other. The AI agents offered by the multi-agent framework may be configured to be further customized for certain user-defined tasks through machine learning techniques such as fine-tuning.

The multi-agent framework server 112 is connected to the first communication network 110 through a framework API server 118. Furthermore, the multi-agent framework server 112 may allow integration of third-party AI agents 142 and 150 supported by several third-party AI servers 138 and 148 through their respective third-party AI agent API servers 136 and 144. Some of the examples of third-party AI agents 142 and 150 that may be integrated with the framework offered by the multi-agent framework server 112 include GoogleAI and OpenAI. It is to be noted that Google AI and OpenAI are examples of services that offer certain kinds of AI agents called LLM agents, however, the present invention is not limited to LLM agents alone and is envisaged to incorporate other kinds of AI agents such as domain-specific AI models, rule-based systems, expert systems, planning algorithms, reinforcement learning agents, human-in-the-loop systems, etc.

FIG. 2 illustrates an example multi-agent framework 200 (hereinafter referred to as “the framework 200”) provided by the multi-agent framework server 112, in accordance with an embodiment of the present invention. The framework 200 includes a web scraper agent 202, a visual web browsing agent 204, a document processing agent 206, an API data agent 208, a user history agent 210, and a questionnaire data agent 212. The web scraper agent 202 is configured to scrape through web pages provided by web servers concerning several different services such as social media, news organizations, blogs, company websites, and the like. Furthermore, the web scraper agent 202 is configured to extract data and useful insights from the scraped web pages. The visual web browsing agent 204 is configured to extract data and insights concerning visual data present in the web pages, such as images, videos, layouts, etc. In that regard, the visual web browsing agent 204 may be able to converse with the web scraper agent 202 to receive access to the web pages visited by the web scraper agent.

The document processing agent 206 is configured to extract data, information, and insights from several different forms of documents such as those available in the form of*.pdf files, *.docx files, *.xlsx files, *.png files, *.jpeg files, *.html files, *.xml files, etc. The documents processing agent 206 may also be able to converse with the visual web browsing agent 204 to receive insights extracted by the visual web browsing agent 204 and integrate those insights into the insights generated from document processing. The API data agent 208 is configured to receive data through API servers of services maintaining industry-specific information and research. Furthermore, the API data agent 208 is configured to extract valuable data and insights from the data received through the API servers. The API data agent 208 may also be configured to converse with the document processing agent 206 to leverage the document processing capabilities of the document processing agent 206 to extract insights from the API data.

The user history agent 210 is configured to collaborate with the document processing agent 206 and converse with the API data agent 208 to extract historical insights concerning the business for which management consulting would be provided. Therefore, the historical insights would be generated using the web pages analyzed by the web scraper agent 202 and the visual web browsing agent 204, and API data analyzed by the API data agent 208. Also, the questionnaire data agent 212 by obtaining historical insights from the user history agent 210 and collaborating with the web scraper agent 202 would generate a questionnaire for receiving valuable insights from the user(s). The questionnaire may be answered by a human user or an LLM agent acting as a simulated user.

Referring to FIG. 1, further connected to the first communication network 110 is a third-party data management server 152 through a third-party data management API server 158. The third-party data management server 152 may be configured to maintain additional organizational data 156 associated with several organizations in a third-party data management storage device 154. For example, the third-party data management server 152 may offer a service applicable to very specific aspects of business such as accounting and finance (for example, Google Analytics, Quickbook, Xero, Sage, etc.), employee payroll data, jurisdiction-wise product availability, and the like. Some of the rationales for moving at least some of the enterprise data to the third-party data management server 152 and the third-party management storage device 154 may include greater protection with higher levels of encryption, limited storage availability with the EDM storage device 104, regulatory requirements in a given jurisdiction, division of responsibilities in between personnel, outsourcing of certain services being more cost-effective compared to vertical integration, and the like.

Further connected to the first communication network 110 is a market research server 130 maintaining proprietary market research data in a plurality of market research storage devices 132. The market research server 130 is connected to the first communication network 110 through a market research API server 129. The market research data concerning a given industry or a product group may include surveys, interviews, outcomes of focus groups, experiments, observations, inferences, market reports (such as industry reports and analysis concerning market size, growth trends, competitor information, etc.), government data (such as information on demographics, economic trends, and consumer spending), media reports (such as articles, blogs, and social media conversations), and company reports (such as financial statements, annual reports, and press releases).

Furthermore, several web servers 160, 162, 164, and 166 hosting several websites and webpages concerning the industry of interest are connected to the first communication network 110 through a second communication network 168. For example, the websites may include social media websites, news publication websites, popular blogs, online marketplaces, online scientific journals, online journals maintained by regulatory bodies (such as the department of trade and commerce), etc. Additionally, a plurality of user computing devices 134 are also connected to the first communication network 110 through a user communication API server 133. The plurality of user computing devices 134 may include smartphones, Personal Digital Assistants (PDA), notebook PCs, tablet PCs, desktop PCs, and the like.

Furthermore, a central server 120 hosting an application representing the present invention is also connected to the first communication network 110. The central server 120 may be representative of a single device, a server stack, or a server farm including capabilities such as those of web servers, gateway servers, load balancers, compute nodes, application servers, database servers, and the like. In that regard, the central server 120 is envisaged to include a processor 122, a memory unit 124, a communication interface 126, and a storage device 128. The method steps of the present invention as will be discussed in the following discussion are envisaged to be performed by the processor 122 executing machine-readable instructions stored in the memory unit 124 and/or the storage device 128. The storage device 128 may store other information such as communication and data-exchange protocols for the exchange of data amongst two or more devices and/or two or more coded software modules, AI agents, LLM agents, and the like, IP addresses of the devices depicted in the environment 100, additional computing code in programming languages such as Python, several JSON libraries, and the like.

The storage device 128 may further be configured to store the data and the information collected, received, and/or generated by the processor 122 during the working of the present invention. The data stored in the storage device 128 may be stored in several database forms such as SQL databases and vector databases. It is to be noted here that the storage device 128 is representative of one or more storage devices located locally or remotely and accessible through corresponding database servers. Moreover, in several embodiments, for maintaining the security and integrity of the data stored in the storage device 128, the data may be stored in encrypted form and exchanged using security protocols such as Secure Service Layer (SSL) or Transport Layer Security (TLS) through public key infrastructure. Additional network firewalls and/or host firewalls may also be implemented for further security against hacking attacks.

Several embodiments of the present invention will now be elucidated using the environment 100 as a reference. However, a person skilled in the art would appreciate that the present invention as described in the following discussion may also be implemented in several alternate environments of computing devices without departing from the scope of the invention.

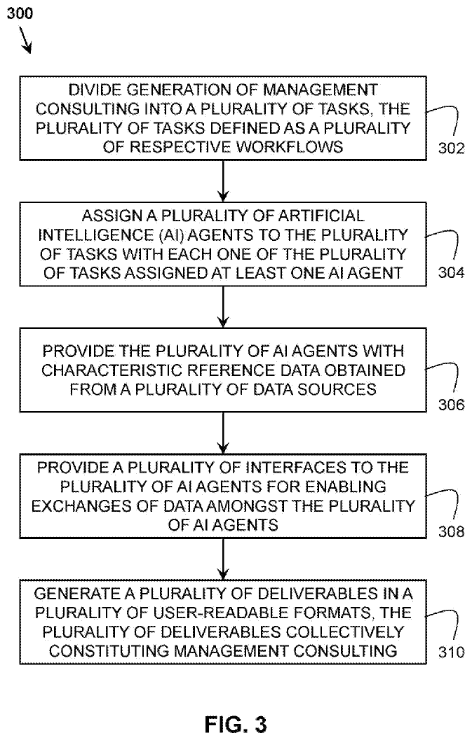

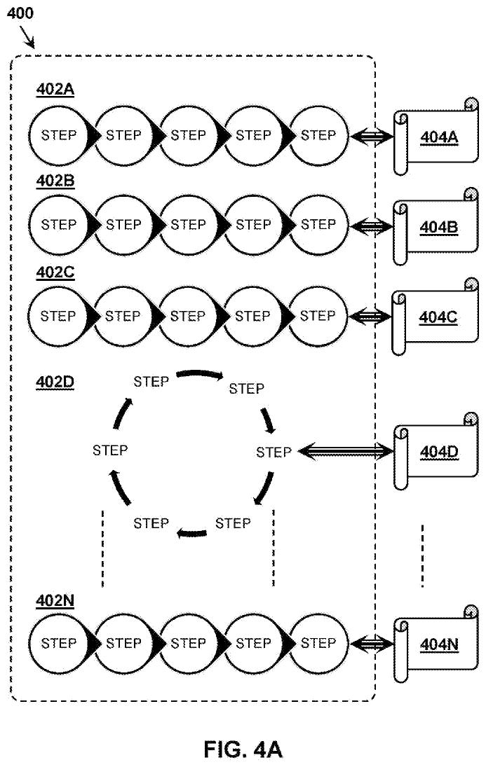

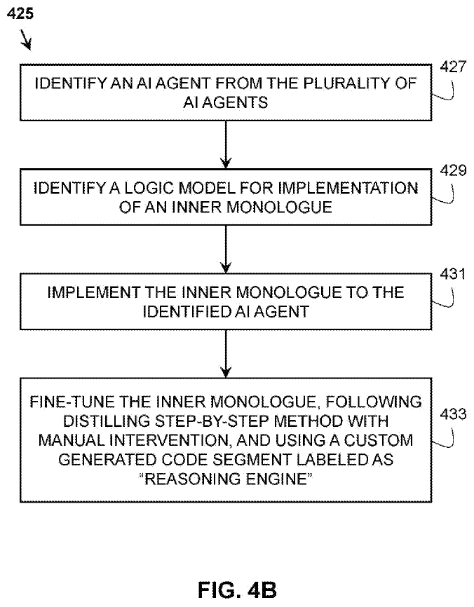

FIG. 3 illustrates a flow chart depicting a computer-implemented method 300 for Artificial Intelligence (AI) based provision of management consulting, in accordance with an embodiment of the present invention. The computer-implemented method 300 begins at Step 302 when the processor 122 divides the provision of management consulting into a plurality of tasks 400 (for example, 402A, 402B, 402C, 402D . . . 402N) as illustrated in FIG. 4A.

Some of the examples of the plurality of tasks 400 may include the generation of corporate strategy, generation of business strategy, generation of go-to-market strategy, generation of digital strategy, organizational restructuring, process improvement, cost reduction, supply chain management, planning mergers and acquisitions, providing financial advice on capital raising, debt restructuring, and dividend policy, risk management, financial modeling, marketing strategy development, sales effectiveness evaluation, and improvement, Customer Relationship Management (CRM), pricing, leadership development, sustainability assessment, leveraging technology and innovation, talent management and organizational development.

In that regard, one or more AI agents when executed by the processor 122 may act as AI editors. The processor 122 executing the AI editors may break the provision of management consulting into several sections of a document (for example, a financial forecasting report). Thereafter, each section of the document may be handled by a dedicated AI agent allowing users to ask questions and make changes. Any changes made may also be populated to a rich document for the content and for the financial forecasts the changes may be fed to a separate editor which feeds into a spreadsheet model allowing for a manual override of the AI-generated assumptions.

Each one of the plurality tasks 400 may further be defined as a workflow. For example, one of the plurality tasks 400 may be to generate a marketing plan. The workflow for generating the marketing plan may include, for example, (1) identifying marketing strengths and weaknesses, (2) generating target consumer groups, (3) formulating goals and initiatives, (4) formulating marketing strategic goals, (5) receiving a user selection from formulated marketing strategic goals, (6) finalizing marketing plan components based on user selection, (7) generating an implementation plan, (8) generating marketing plan report, (9) review and editing of the generated marketing plan report, and (10) exporting information into Gantt Charts and Key Performance Indicators (KPIs). It is to be noted here that the present invention is not limited to linear workflows alone. FIG. 4A depicts the plurality of tasks 400 to include linear workflows 402A, 402B, 402C, and 402N, and a non-linear or cyclic workflow 402D. For example, a dynamically generated and modifiable business plan may be an example of a non-linear or cyclic workflow.

Referring to FIG. 3, At Step 304, the plurality of tasks 402A, 402B, 402C, 402D . . . 402N are assigned the plurality of AI agents 404A, 404B, 404C, 404D . . . 404N by the processor 122. It is to be noted here that each one of the plurality of tasks 402A, 402B, 402C, 402D . . . 402N is assigned at least one AI agent. In general, whether accessing the AI agents 116 of the multi-agent framework 200 or the third-party AI agents 142 and 150, the AI agents have already been trained by aforementioned methods using generalized corpuses available through the Internet. However, it may be desirable that the plurality of AI agents 404A, 404B, 404C, 404D . . . 404N are further customized to suit industry-specific information for which the management consulting is being developed. In several embodiments of the invention, one or more of the plurality of AI agents 404A, 404B, 404C, 404D . . . 404N may further be customized by training the one or more of the plurality of AI agents 404A, 404B, 404C, 404D . . . 404N using fine-tuning techniques in conjunction with task-specific real-life examples and JSON data.

Fine-tuning of the plurality of AI agents 404A, 404B, 404C, 404D . . . 404N can be performed in several manners. The fine-tuning can be data-driven where an AI agent is trained on a focused dataset relevant to a specific task that the AI agent has been assigned. Furthermore, data-driven fine-tuning can deploy any one or more of supervised learning, reinforcement learning, and imitation learning. Another form of fine-tuning is called prompt engineering, where prompts are adjusted specifically to receive tailor-made desired outputs from the AI agent. Prompt engineering is often used in conjunction with data-driven fine-tuning. Another form of fine-tuning includes parameter optimization. In parameter optimization, internal parameters of the corresponding neural network of an agent are directly adjusted based on feedback and performance metrics.

Self-improvement techniques may also be used for fine-tuning. Some examples of self-improvement techniques include meta-learning, where the AI agent learns how to learn allowing the AI agent to adapt to new tasks and environments, transfer learning, where knowledge and experience from previously learned tasks are applied to new tasks and environments, and agent self-analyses, where the AI agent evaluates its performance to identify areas of improvement. In addition to data-driven fine-tuning, prompt engineering, parameter optimization, and self-improvement techniques, there might be other fine-tuning techniques that may deployed to improve the efficiency and performance of the plurality of AI agents 404A, 404B, 404C, 404D . . . 404N. An example of fine-tuning is few-shot learning. Few-shot learning techniques offer several advantages such as quick adoption of new tasks, reduced data requirements, improved performance on small datasets, and increased AI capabilities.

FIG. 4B illustrates a method 425 for fine-tuning an AI agent of the plurality of AI agents 404A, 404B, 404C, 404D . . . 404N, in accordance with an embodiment of the present invention. The method 425 begins at Step 427 when an AI agent (for example, “the AI agent 404B”) is identified for fine-tuning. In Step 429, a logic model for the implementation of an inner monologue is identified. More information on the implementation of the inner monologue can be found in the web publication arXiv: 2207.05608v1 which is incorporated herein by reference, in its entirety. For example, the logic model may be Chain-of-Thought (CoT) prompting (web publication arXiv: 2201.11903v6) or Tree-of-Thought (ToT) prompting (web publication arXiv: 2305.10601v2).

In Step 431, the inner monologue is implemented to the identified AI agent 404B. During the implementation of the inner monologue, the AI agent 404B is provided with closed-loop context-based feedback in natural language. The feedback, in that regard, may be provided in several different forms such as success detection, context-description, and human interaction. Therefore, by leveraging the context-based feedback, the AI agent 404B can form the inner monologue that allows the AI agent 404B to richly process the information being received by the AI agent 404B. Furthermore, at Step 433, the inner monologue is itself fine-tuned. In that regard, for fine-tuning the inner monologue, distilling step-by-step methodologies may be applied to extract intermediate natural language rationales from pre-existing LLM agents.

The extracted rationales can then in turn be used to train the AI agent 404B in a more efficient manner. For example, an LLM agent can be prompted with a few-shot chain-of-thought (CoT) prompting technique to obtain the intermediate rationales. Furthermore, LLM agents may also be prompted with tree-of-thought (ToT) reasoning to obtain several intermediate rationales and output labels between initial input and final output labels. The input labels may be provided through manual intervention. Furthermore, through manual intervention, few-shot exemplars are generated, with each example containing a triplet of (1) input, (2) rationale, and (3) output. The few-shot exemplars are then prompted to the pre-exiting LLM agents to enable the pre-existing LLM agents to generate rationales for future unseen inputs.

The generated rationales are then fed to the AI agent 404B as training data using a custom-generated code segment (labeled as “reasoning engine” for the purposes of the specification). In that regard, the inner monologue is fine-tuned in such a manner that the AI agent 404B is trained for the rationale generation task in addition to the label prediction task. The rationale generation task enables the AI agent 404B to learn to generate the intermediate reasoning steps for the prediction and guides the AI agent 404B to better predict the resultant label. More information on distilling step-by-step methodologies, CoT prompting and use of inputs, rationales, and output labels for training smaller models can be found in the web publication arXiv: 2305.02301v2, which is incorporated herein by reference, in its entirety.

At Step 306, the processor 122 provides the plurality of AI agents 404A, 404B, 404C, 404D . . . 404N with characteristic reference data obtained from a plurality of data sources. The characteristic reference data may include real-world examples in the form of case studies, financial statements, contracts, marketing materials, demographics, and interview transcripts. The plurality of data sources may include goods and/or services data, scraped data, market research, short-term memory data, long-term memory data, automated information management services, and user uploads. Moreover, the processor 122 may deploy several data extraction techniques to obtain the characteristic reference data. Such data extraction techniques may include the use of the application of AI assistant retrieval agents, Retrieval-Augmented Generation (RAG) agents, web scraper agents, and visual web browsing agents. Furthermore, the data extraction techniques may utilize Optical Character Recognition (OCR), machine readings, text summarization, sentiment analysis, intent detection, Named Entity Recognition (NER), and Natural Language Processing (NLP).

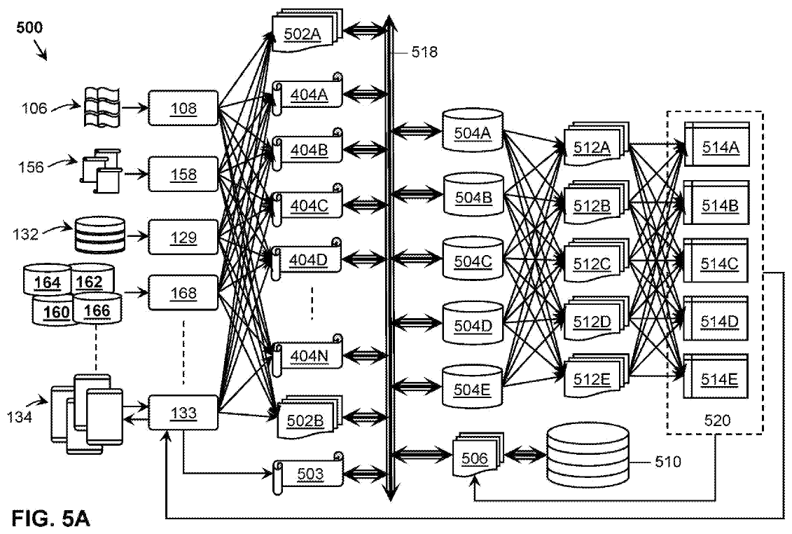

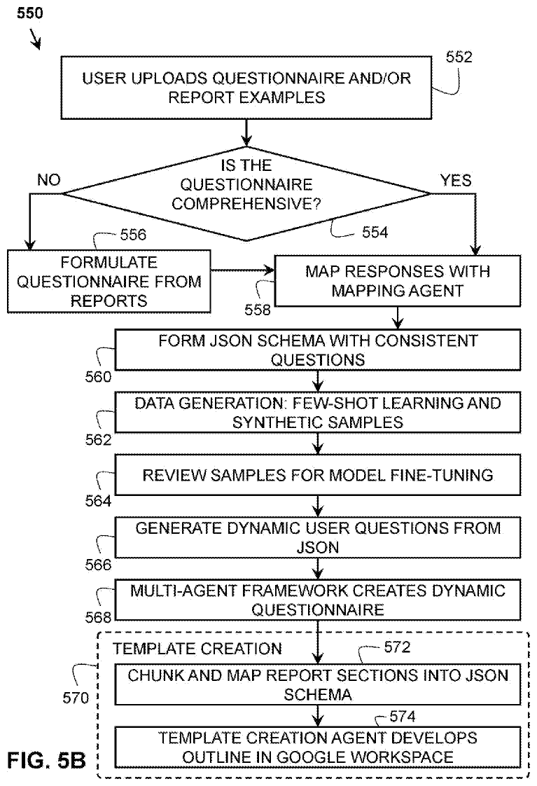

FIG. 5A illustrates a pictorial representation of the AI-based provision of management consulting, in accordance with an embodiment of the present invention. The goods and/or services data may be obtained in the form of EDM data files 106 derived from the EDM storage device 104 through the EDM server 102 and the firewall 108. The EDM data files 106 may be available in several different formats such as *.docx, *.xlsx, *.pdf, *.png, *.jpeg, and other proprietary file formats. Furthermore, additional organizational data 156 may be obtained from third-party data management storage device 154 through the third-party data management server 152 and the third-party data management API server 158. Here again, the additional organizational data 156 may be available in several different formats such as *.docx, *.xlsx, *.pdf, *.png, *.jpeg, and other proprietary file formats.

In that regard, the processor 122 may perform post-processing such as Optical Character Recognition (OCR), image processing, parsing, etc. to convert the obtained EDM data files 106 and the additional organizational data 156 into JSON objects. The JSON objects may then be absorbed by the plurality of AI agents 404A, 404B, 404C, 404D . . . 404N. The conversion of EDM data files 106 and the additional organizational data 156 into JSON objects may be added to the plurality of AI agents 404A, 404B, 404C, 404D . . . 404N through custom-generated features coded in a compatible programming language such as Python. The custom-generated features are represented by code segments 502A and 502B in FIG. 5.

The short-term memory data such as sales figures, inventory levels, customer feedback, and short-term market trends, and the long-term memory data such as historical performance data, customer demographics, and behavior, and to some extent, competitive landscape and industry trends may also be extracted by the processor 122 from the EDM data files 106 and the additional organizational data 156. In another context, short-term memory may be attributed to in-context memory and knowledge passed in JSON stored temporarily to assist in a long-sequence chain of thought reasoning (for example, What should I have for dinner today? I had Cheese yesterday, but don't remember what I had a week ago). However, long-term memory is context retrieved via the RAG agent (E.g. I am on a diet and have been for the past eight months).

In an example context of the present invention, the framework followed by the RAG agent may include six (6) steps including:
a. Splitting and Chunking: Each page of a document is split in a predefined precedence (for example, ‘\n\n’, ‘\n’, ‘ ’,”) and the size of each split (also referred to as a chunk) is about three-hundred and fifty (350) characters with a hundred and thirty-five (135) character overlap. The reason for a smaller chunk size is that a more granular search can be performed which helps identify information that is not readily accessible.
b. Saving vectors: Vectors are then saved in a vector database, by adding an index (like page number, that will be useful in the later stages) to each one of the vectorized chunks.
c. Query enhancement: Once the vectors are saved in the vector database, a user query is accessed, and multiple different versions (for example, three (3) to five (5) versions) of the accessed user query are generated. The multiple different versions may be attributed to multiple different manners in which the same user query can be rephrased without changing the substantive meaning of the query.
d. Retrieval: A predefined number of chunks (for example, top three (3) chunks) are retrieved for all the different versions of the accessed user query.
e. Extending the chunks: One (1) to two (2) chunks ahead and prior for all the top chunks are also fetched in addition to the predefined number of chunks. All of the retrieved and/or fetched chunks are utilized during the generation of the answers. The rationale for fetching additional chunks lies in the fact that sometimes during the similarity search on the vector chunks, similar content is present at the top or the bottom of the page, which might have continuation or prior information on that topic respectively, and those texts might get missed if only the originally retrieved top chunks are used for generating the answers.
f. Generating Answers: All of the retrieved and/or fetched chunks are then sent to an AI agent responsible for generating the answers.

The short-term and long-term memory data may then be parsed and converted into JSON objects by the processor 122 for absorption by the plurality of AI agents 404A, 404B, 404C, 404D . . . 404N. Other sources of short-term and long-term memory data may include Automated Information Management Services such as Enterprise Content Management (ECM), Document Management Systems (DMS), Business Intelligence (BI) and analytics platform, Customer Relationship Management (CRM) systems, Enterprise Resource Planning (ERP) systems, and Electronic Content Management (ECM) systems all of which may be available through EDM data files 106 and the additional organizational data 156.

In several embodiments of the invention, the processor 122 may further provide an upload link to the user to upload documents in several different formats such as *.docx, *.xlsx, *.pdf, *.png, *.jpeg to the storage device 128, using the plurality of user computing devices 134 and through the user communication API server 133. In several alternate embodiments, one of the plurality of AI agents 404A, 404B, 404C, 404D . . . 404N may generate a questionnaire or a survey based on information received from the EDM data files 106 and the additional organizational data 156 and present the questionnaire or the survey to the user at the plurality of user computing devices 134. The user may then respond to the questionnaire or the survey, which may then be converted into JSON objects by the processor 122. The JSON objects thus generated may then be fed to one or more of the plurality of AI agents 404A, 404B, 404C, 404D . . . 404N.

The scraped data may be obtained by the web scraper agents visiting several websites including the websites of users accessing the services claimed through the present invention, competitor websites, websites of regulatory bodies, periodic industrial surveys published online by private and public agencies, popular online magazines publications, newsletters, journals, and blog posts concerning the industry to which the user belongs. Such websites and webpages may be made available by web servers 160, 162, 164, and 166 and may be accessible to the processor 122 through the first communication network 110 and the second communication network 168. Here again, the code segments 502A and 502B may enable the plurality of AI agents 404A, 404B, 404C, 404D . . . 404N to obtain useful information from the websites and the webpages.

The processor 122 may further obtain the market research data from the market research storage devices 132 through the market research server 130 and the market research API server 129. The market research data in that regard may include opinions, preferences, buying habits, and demographics of the consumers, strengths, weaknesses, market share, and strategies of the competitors, overall size, growth trends, segmentation, and potential opportunities in the market, and appeal, price sensitivity, and potential for success of proposed goods and services. The market research data may also be an additional source of long-term memory data for the processor 122.

In several scenarios, pre-existing LLM agents may be used as some of the plurality of AI agents 404A, 404B, 404C, 404D . . . 404N. The LLM agents have conventionally been trained on large amounts of text data, therefore they are not as good at understanding numerical relationships and operations as they are in the context of text-based information. Although LLM agents with increased dexterity in manipulating numerical data are always emerging they still have a long way to go before they can be accepted as reliable business tools for handling numerical data. Such shortfall may be addressed by the code segments 502A and 502B, in a manner that the code segments 502A and 502B, when executed by the processor 122, add custom-generated features to the plurality of AI agents 404A, 404B, 404C, 404D . . . 404N enabling the present invention to handle and manipulate numerical relationships and operations.

Referring to FIG. 3, at Step 308, the processor 122 provides a plurality of interfaces to the plurality of AI agents 404A, 404B, 404C, 404D . . . 404N for enabling exchanges of data amongst the plurality of AI agents 404A, 404B, 404C, 404D . . . 404N. The plurality of interfaces is represented by a common communication bus 518 in FIG. 5. In that regard, anyone AI agent of the plurality of AI agents 404A, 404B, 404C, 404D . . . 404N can communicate with any other AI agents of the plurality of AI agents 404A, 404B, 404C, 404D . . . 404N using one or more of the plurality of interfaces, such as through the common communication bus 518. It is to be noted here that in several embodiments of the invention, the common communication bus 518 may be replaced with several independent communication buses each allowing the exchange of data and information between two or more AI agents and/or coded segments through distinct protocols. In that regard, the specific architecture of the implementation of the plurality of interfaces may differ from one application paradigm of the present invention to another application paradigm. For example, the plurality of interfaces may utilize Application Programming Interfaces (APIs), data translation protocols, messaging formats, and object models to enable communication between the plurality of AI agents 404A, 404B, 404C, 404D . . . 404N.

Furthermore, the processor 122 may define inter-agent communication protocols for efficient communication amongst the plurality of AI agents 404A, 404B, 404C, 404D . . . 404N. The provision of the plurality of interfaces allows services offered through the present invention to be modular in architecture. A module may be defined using one or more AI agents for achieving a set of functional objectives. Therefore, different modules may be combined in several different manners to customize the present invention for different industry types, industry sizes, and business objectives. The user(s) may communicate with the plurality of AI agents 404A, 404B, 404C, 404D . . . 404N using one or more of the user computing devices 134. The receipt of user inputs may be facilitated by the processor 122 executing a user-proxy agent 503. For example, during the generation of the marketing plan as discussed in the preceding discussion, the formulated strategic goals may be presented as several ‘Tables of Contents’ to the user. The user may (5) select one specific table of contents or choose segments from the distinct tables of contents to generate a customized table of contents. Steps (6) to (10) may then be carried out in conformity with user selected or generated table of contents.

In several embodiments of the invention, the user-proxy agent 503 may act as a voice-interview agent that collects information from a human user and utilizes a voice-to-text API to enable voice communication with a user using several mediums such as through GSM, VOIP, VOLTE, or VoWiFi, etc. to collect the desired information. Answers to the questions asked by the interview agent are then processed by the processor 122 before being entered into the JSON library containing several fields of information about the business or the company for which the management consulting is being provided. In either of the scenarios, where the user is being asked questions in the text-form or the voice-form by the user-proxy agent 503, the user-proxy agent 503 may further be configured to generate a dynamic questionnaire based on gaps left after all other sources of information such as Self-Querying Doc Uploads, Voice Transcriptions, or inputs our outputs of prior plans generated have been analyzed. In that regard, additional fields labeled as “Clarifying Questions” may be generated and populated dynamically based on the information needed for the specific report section, company stage, industry, etc. The received user inputs required at one or more stages of provision of management consulting may then be provided to the plurality of AI agents 404A, 404B, 404C, 404D . . . 404N by the processor 122.

Moreover, by providing the plurality of interfaces, the method 300 of the provision of management consulting may be completely automated as one of the AI agents may be used to simulate a user for another AI agent. For example, if one of the AI agents generated a questionnaire or a survey based on market research data, another AI agent may act as a simulated user responding to the survey based on short-term memory data and long-term memory data. In another scenario, one of the AI agents may assume the role of a validator and may perform validation of the generated management consulting based on industry benchmark data extracted from market research data and data obtained from webpages of industry regulators, census publications, and other public and private non-profit research groups.

The processor 122 implementing the plurality of AI agents 404A, 404B, 404C, 404D . . . 404N may be able to generate a large amount of data concerning the intended goals of the present invention. The data generated by the processor 122 implementing the plurality of AI agents 404A, 404B, 404C, 404D . . . 404N may pertain to financial forecasting, dynamically generated and modifiable business plans, market research plans, operating plans, and expansion plans. For example, the RAG agent may use the vector databases of storage device 128 to generate data which may later be used by an AI agent acting as a simulated user for generating marketing plans or expansion plans. The AI agent acting as the simulated user may also have access to the SQL databases and all other forms of data, using which the AI agent may formulate a strategy for the provision of management consulting. Such information may be stored in information repositories 504A, 504B, 504C, 504D, and 504E as shown in FIG. 5A.

Referring to FIG. 3 and FIG. 5A, at Step 310, the processor 122 may then execute deliverable-generating code segments 512A, 512B, 512C, 512D, and 512E to generate a plurality of deliverables 514A, 514B, 514C, 514D, and 514E using the data stored in the information repositories 504A, 504B, 504C, 504D, and 504E. The deliverable-generating code segments 512A, 512B, 512C, 512D, and 512E may include machine-readable instructions for implemented Google Workspace Templates, Gantt Chart generators, and Key Performance Indicator (KPI) generators. The plurality of deliverables 514A, 514B, 514C, 514D, and 514E may be generated in user-readable formats such as a dashboard interface, spreadsheets, and rich text format. For example, the plurality of deliverables 514A, 514B, 514C, 514D, and 514E may include Google Workspace Documents created using Google Workspace Templates, Gantt Charts generated by Gantt Chart generators, and KPIs generated by KPI generators.

Moreover, the plurality of deliverables 514A, 514B, 514C, 514D, and 514E together constitute management consulting 520. In several embodiments of the invention, the plurality of deliverables 514A, 514B, 514C, 514D, and 514E may include financial forecasting, dynamically generated and modifiable business plans, market research plans, operating plans, and expansion plans. In several embodiments of the invention, the deliverable-generating code segments 512A, 512B, 512C, 512D, and 512E may further provide mapping functions enabling the processor to translate data from one user-readable format to another user-readable format, of the plurality of user-readable formats.

In several embodiments of the invention, the processor 122 may then validate the plurality of deliverables 514A, 514B, 514C, 514D, and 514E by executing a validation code segment 506 using industry benchmark data stored in an industry benchmark data database 510, as a reference. In that regard, for validating the plurality of deliverables 514A, 514B, 514C, 514D, and 514E, the processor 122 may utilize metrics including Key Performance Indicators (KPIs), benchmarking, regression analysis, gap analysis, and requirements traceability matrices. The industry benchmark data database 510 may be maintained in the storage device 128. Furthermore, the processor 122 may further receive user feedback on the plurality of deliverables 514A, 514B, 514C, 514D, and 514E through surveys, query responses, and explicit ratings. In case, the plurality of deliverables 514A, 514B, 514C, 514D, and 514E do not conform with the industry benchmark data, the processor 122 may then modify one or more of the plurality of tasks, the plurality of AI agents 404A, 404B, 404C, 404D . . . 404N, and the characteristic reference data provided to the plurality of AI agents 404A, 404B, 404C, 404D . . . 404N, following the failure of the validation of the plurality of deliverables 514A, 514B, 514C, 514D, and 514E. Steps 302-310 may be repeated until certain predefined performance thresholds, such as, convergence with industry benchmark data are achieved.

After the convergence is validated by the processor 122, the plurality of deliverables 514A, 514B, 514C, 514D, and 514E may be provided to the user(s) at the plurality of user computing devices 134, and through the user communication API server 133. In several embodiments, the user(s) may be able to provide feedback using user interfaces provided at the user computing device 134. The user-proxy agent 503 on execution may then allow the processor 122 to receive the feedback through the user communication API server 133 and refine and/or further modify the one or more of the plurality of tasks, the plurality of AI agents 404A, 404B, 404C, 404D . . . 404N, and the characteristic reference data in response to receipt of the feedback.

FIG. 5B illustrates a flowchart depicting an example implementation 550 of the computer-implemented method 300 for the AI-based provision of management consulting, in accordance with an embodiment of the present invention. The implementation begins at Step 552 when the processor 122 receives user uploads in the form of a questionnaire and/or multiple report examples. At Step 554 processor 122 determines if the questionnaire uploaded by the user is comprehensive or not. If not, then at Step 556, the processor 122 formulates a questionnaire by identifying common facts and data points from the report examples. Consequently, or alternatively, at Step 558, the processor 122 executes a mapping agent to correlate questionnaire responses with relevant fields. In that regard, the mapping agent which might be an AI agent or a user-defined code segment, identifies the source of facts and figures, labeling them as derived from the questionnaire or indicating an alternative likely source of origin. At Step 560, the processor 122 forms a JSON schema based on the questionnaire. Furthermore, the processor 122 incorporates similar questions identified as consistent across several template examples.

At Step 562, the processor 122 deploys few-shot learning data or a pre-existing LLM to generate multiple synthetic samples. At Step 564, the synthetic samples may then be reviewed by a human user for fine-tuning of one or more AI agents. At Step 566, the processor 122 generates a list of user-specific questions based on the JSON schema. At Step 568, the processor 122, executing the multi-agent framework 200, creates a dynamic questionnaire for collecting additional information. At Step 570, the processor 122 creates a template. The template creation essentially involves two steps. At Step 572, the processor 122 chunks each section of the report into a JSON schema. Furthermore, the processor 122 maps the chunks to the questionnaire sources, creating few-shot learning examples. At Step 574, the processor 122 executing a template creation agent, which may be an AI-based agent or a user-defined code segment, develops a table of contents and outline within a Google Workspace file. Furthermore, the processor 122 then maps JSON field names to the previous template JSON, preparing the structure for content writing.

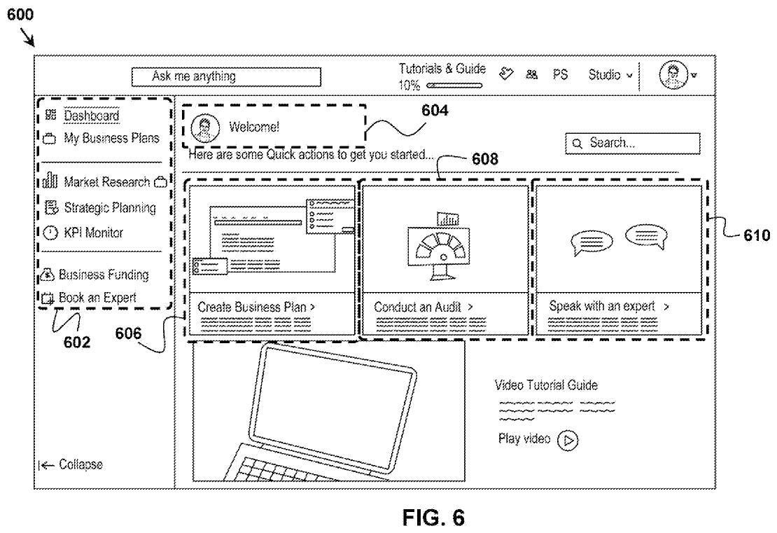

FIG. 6 illustrates an example dashboard Graphic User Interface (GUI) 600 of a computer-implemented application implementing several embodiments of the present invention. The dashboard GUI 600 illustrates a list of services or deliverables 602 offered by the computer-implemented application (hereinafter also referred to as “the solution”). For example, the list of deliverables 602 includes business planning, market research, strategic planning, Key Performance Indicators (KPI) monitoring, etc. The dashboard GUI 600 also illustrates user information 604 such as name, registration number, and address. legal jurisdiction, etc. of a business entity accessing the service offered by the solution. Also provided a links to several deliverables offered, such as a business plan 606, an audit report 608 (for example a financial audit, a quality control audit, an information security protocol audit, etc.), and consultation with an expert 610. The consultation may be provided by a human operator or an AI agent of the plurality of AI agents 404A, 404B, 404C, 404D . . . 404N, acting as a simulated user and using all the additional references available to the AI agent from the plurality of data sources.

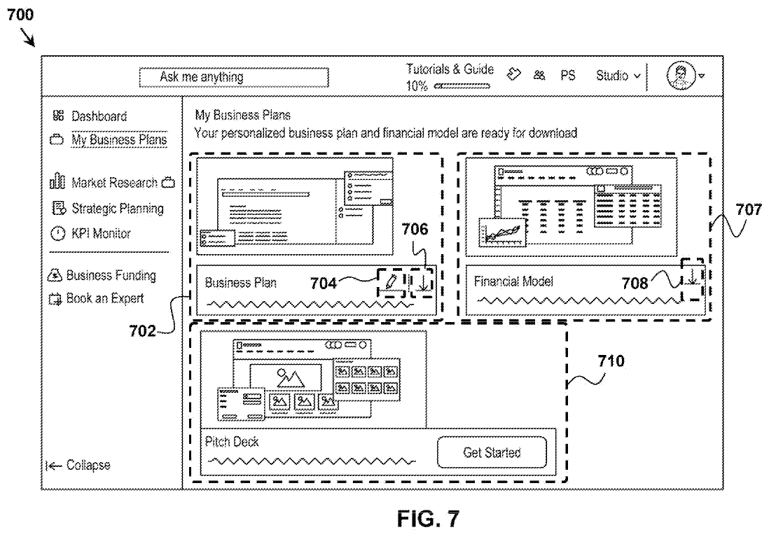

FIG. 7 illustrates an example GUI 700 depicting several deliverables offered as a part of a business plan, by the computer-implemented application of FIG. 6. The deliverables may include a business plan document 702 in rich text format, which may be edited through an editing link 704 or downloaded as a Microsoft Word document or as another compatible rich text format document using a download link 706. Furthermore, a financial model 707 including historical and/or projected financials may be provided in a spreadsheet format. The spreadsheet format may be downloaded as a Microsoft Excel file using another download link 708. Also, as a part of the business plan, there may be a pitch deck 710 that may be automatically populated by the plurality of AI agents 404A, 404B, 404C, 404D . . . 404N for pitching the business plan to investors and other stakeholders.

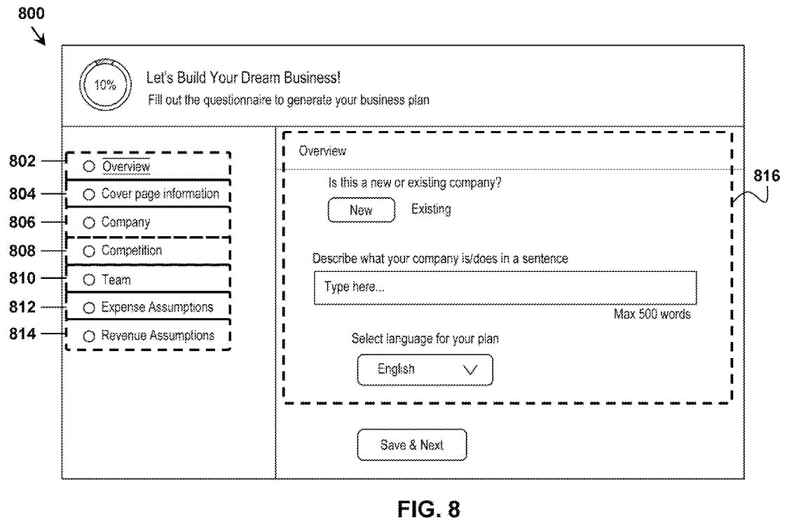

FIG. 8 illustrates an example GUI 800 depicting a questionnaire 816 generated by one or more AI agents of the computer-implemented application of FIG. 6. The questionnaire 816 may be responded to by human users using the plurality of user computing device 134 or may be responded to by one or more of the plurality of AI agents 404A, 404B, 404C, 404D . . . 404N acting as a simulated user through the common communication bus 518. It can be further seen that the questionnaire 816 has been divided into a plurality of sections 802, 804, 806, 808, 810, 812, and 814. Each one of the plurality of sections 802, 804, 806, 808, 810, 812, and 814 may correspond to one or more tasks in which the provision of management consulting was divided. In that regard, the questionnaire in each section may be generated by the processor 122 implementing combinations of the plurality of AI agents 404A, 404B, 404C, 404D . . . 404N that were assigned to the plurality of tasks 400. While human operators or other combinations of assigned and non-assigned AI agents may respond to the questionnaire.

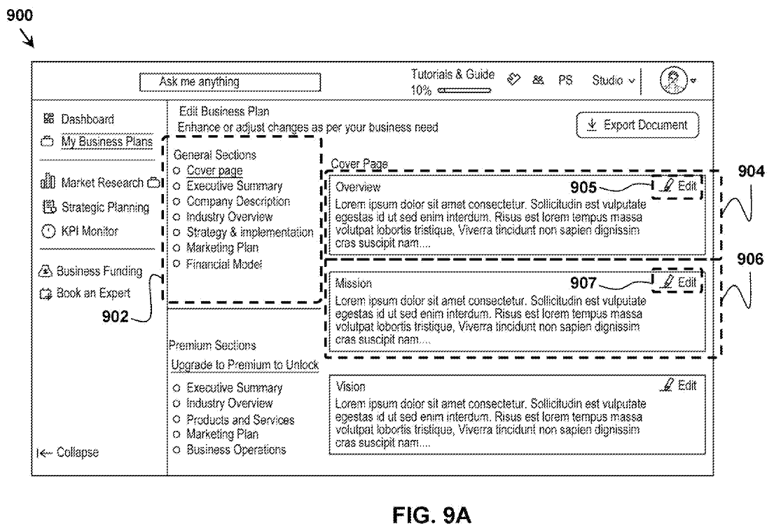

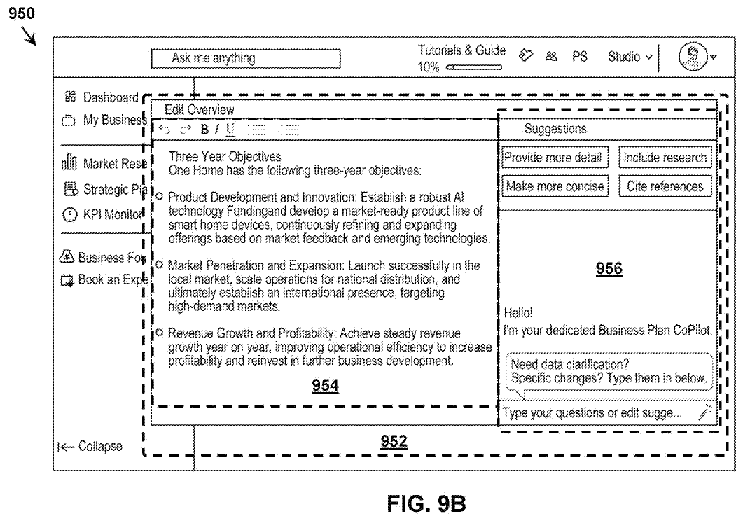

FIG. 9A illustrates an example GUI 900 depicting several sections of a business plan 902 as a deliverable generated by the processor 122 implementing the computer-implemented application of FIG. 6. The several sections may include an overview 904, a mission statement 906, etc. Moreover, respective editing links 905 and 907 have been provided allowing a user to manually modify each section individually. Furthermore, it is to be noted that the generation of the business plan may have been divided into several tasks such as competitive comparison, strategy and implementation, marketing plan, and financial modeling performed by several different combinations formed from the plurality of AI agents 404A, 404B, 404C, 404D . . . 404N.

FIG. 9B illustrates an example GUI 950 depicting one or more ways in which the business plan 902 of FIG. 9A may be edited by a user. The GUI 950 depicts an editing pop-up window 952 that further includes two more windows. The two more windows include a manual editing window 954 and an AI agent-mediated editing window 956. The user may manually edit the text of one or more sections of the business plan in the manual editing window 952. Alternately, the user may engage in a simulated conversation with an AI agent of the plurality of AI agents 404A, 404B, 404C, 404D . . . 404N, in the AI agent-mediated editing window 956. Based on the responses received from the user, the AI agent in combination with one or more additional AI agents using the characteristic reference data may edit the section of the business plan depicted in the pop-up window 952.

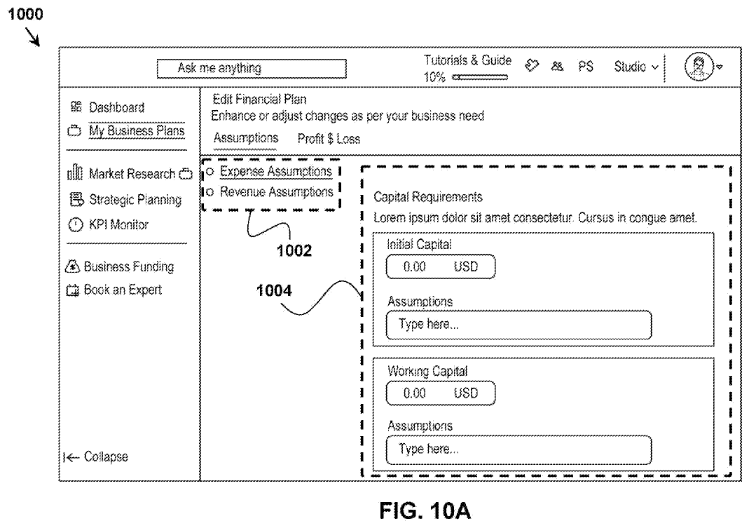

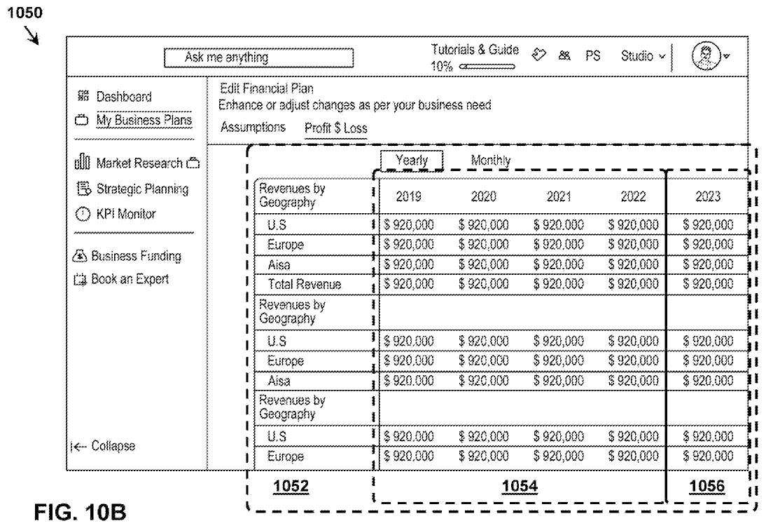

FIG. 10A illustrates an example GUI 1000 depicting a questionnaire 1004 generated by the processor 122 implementing one or more AI agents for generating a financial plan as a deliverable by the computer-implemented application of FIG. 6. Here again the questionnaire 1004 may be generated by the processor 122 implementing one or more of the plurality of AI agents 404A, 404B, 404C, 404D . . . 404N. The questionnaire 1004 may relate to expense and revenue assumptions segments 1002 and may be answered by human users through the plurality of user computing device 134 or may be answered by different combinations of code segments 502A and 502B and one or more AI agents of the plurality of AI agents 404A, 404B, 404C, 404D . . . 404N. FIG. 10B illustrates an example GUI 1050 depicting a comparison 1052 between historical financial data 1054 and a projected financial plan 1056 generated by the processor 122 implementing the computer-implemented application of FIG. 6. The projected financial plan 1056 may be generated by the processor 122 implementing one or more of the plurality of AI agents 404A, 404B, 404C, 404D . . . 404N using the characteristic reference data and/or the responses to questionnaire 1004.

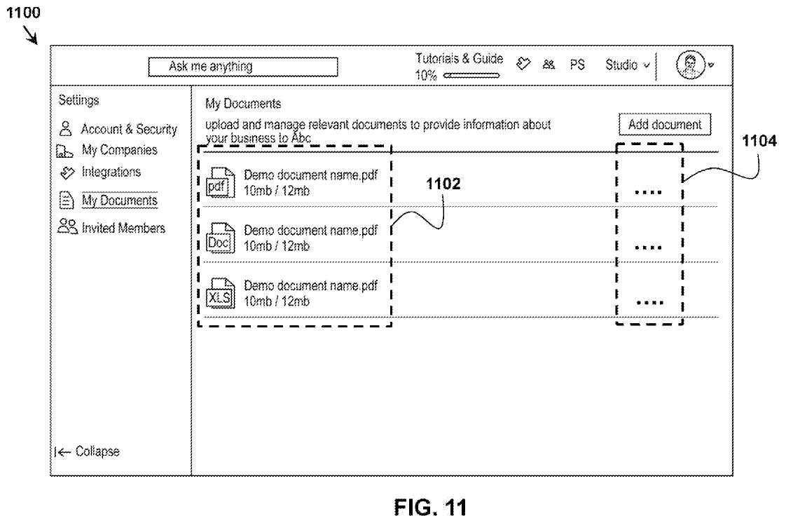

FIG. 11 illustrates an example GUI 1100 depicting documents 1102 uploaded by a user as the characteristic reference data to the computer-implemented application of FIG. 6. The user may upload the documents 1102 using the plurality of user computing devices 134. Furthermore, the GUI 1100 provides description links 1104 allowing the user to add descriptions relating to the documents, such as name of the document, type of information on the document, date of creation, source of data, file format, etc. allowing the processor 122 to assign suitable AI agents to the uploaded documents.

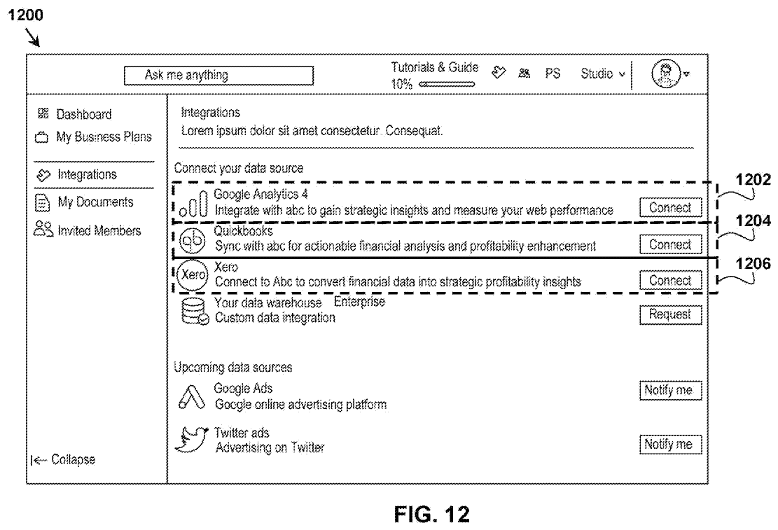

FIG. 12 illustrates an example GUI 1200 depicting the integration of data available from third-party data management services 1202, 1204, and 1206, as the characteristic reference data to the computer-implemented application of FIG. 6. The third-party data management services 1202, 1204, and 1026 may be available through the third-party data management servers 152 and the third-party data management API servers 158. In the given example GUI 1200, the third-party data management services include Google Analytics 1202, Quickbook 1204, and Xero 1206.

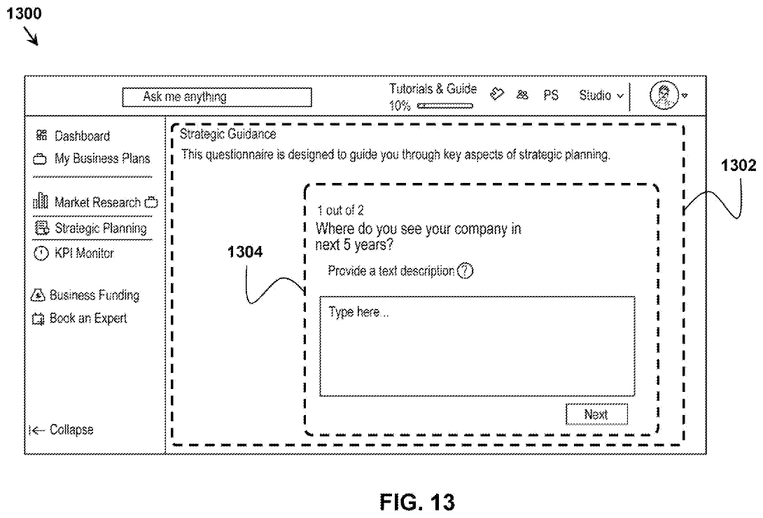

FIG. 13 illustrates an example GUI 1300 depicting the initiation of generation of an expansion plan 1302 for a given business entity, by the computer-implemented application of FIG. 6. As illustrated in FIG. 13, the processor 122 implementing the computer-implemented application initiates a questionnaire 1304 by implementing one or more AI agents for the generation of the expansion plan 1302 as a deliverable.

The present invention, as described through the embodiments discussed above offers several advantages. For example, the entire process of management consulting can be fully automated and scaled up or down to meet the demands of several kinds of businesses with several different sizes in terms of revenues or personnel. The AI agents can be combined in multiple ways to generate modules that may further be combined in several different manners to generate a large and varied set of management consulting solutions. The solution can be fully automated and therefore requires minimal human intervention allowing the solution to be provided at relatively lower costs allowing even small businesses to have access to quality data-based management consulting services. Since the solution leverages a lot of historical data and systems already associated with the concerned business, the deliverables offered are highly customized and can be seamlessly integrated into existing processes. The customized solutions also greatly diminish the inertia that is generally experienced in businesses undergoing radical changes to their current processes.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

1. A computer-implemented method for Artificial Intelligence (AI) based provision of management consulting, the computer-implemented method comprising:
dividing the provision of management consulting into a plurality of tasks, the plurality of tasks defined as a plurality of respective workflows;
assigning a plurality of Artificial Intelligence (AI) agents to the plurality of tasks with each one of the plurality of tasks assigned at least one AI agent;
providing the plurality of AI agents with characteristic reference data obtained from a plurality of data sources;
providing a plurality of interfaces to the plurality of AI agents for enabling exchanges of data amongst the plurality of AI agents; and
generating a plurality of deliverables in a plurality of user-readable formats, the plurality of deliverables collectively constituting management consulting.

2. The computer-implemented method as claimed in claim 1, wherein the plurality of data sources comprises Enterprise Resource Planning (ERP) systems, Customer Relationship Management (CRM) systems, web servers, social media APIs, Electronic Content Management (ECM) systems, and public financial databases.

3. The computer-implemented method as claimed in claim 1, wherein the characteristic reference data comprises real-world examples in the form of case studies, financial statements, contracts, marketing materials, demographics, and interview transcripts.

4. The computer-implemented method as claimed in claim 1, further comprising receiving one or more user inputs from a user computing device through a user-proxy agent.

5. The computer-implemented method as claimed in claim 1, wherein one or more of the plurality of AI agents are further customized by training the one or more of the plurality of AI agents using fine-tuning techniques to fine-tune the one or more AI agents.

6. The computer-implemented method as claimed in claim 1, wherein fine-tuning of the one or more AI agents comprises:
identifying an AI agent from the plurality of AI agents,
identifying a logic model for implementation of an inner monologue,
implementing the inner monologue to the identified AI agent, and
fine-tuning the inner monologue by distilling step-by-step method with manual intervention, and using a custom-generated code segment.

7. The computer-implemented method as claimed in claim 1, wherein the characteristic reference data is provided in forms of real-world examples and JavaScript Object Notation (JSON) data.

8. The computer-implemented method as claimed in claim 1, further comprising validating the plurality of deliverables using industry benchmark data as a reference.

9. The computer-implemented method as claimed in claim 8, wherein validating the plurality of deliverables further comprises utilizing metrics including Key Performance Indicators (KPIs), benchmarking, regression analysis, gap analysis, and requirements traceability matrices.

10. The computer-implemented method as claimed in claim 8, wherein validating the plurality of deliverables further comprises receiving user feedback through surveys, query responses, and explicit ratings.

11. The computer-implemented method as claimed in claim 8, further comprising modifying one or more of the plurality of tasks, the plurality of AI agents, and the characteristic reference data provided to the plurality of AI agents following failure of the validation of the plurality of deliverables.

12. The computer-implemented method as claimed in claim 1, wherein the characteristic reference data is obtained automatically through a plurality of data extraction techniques.

13. The computer-implemented method as claimed in claim 12, wherein the plurality of data extraction techniques comprises application of AI assistant retrieval agents, Retrieval-Augmented Generation (RAG) agents, web scraper agents, and visual web browsing agents.

14. The computer-implemented method as claimed in claim 12, wherein the plurality of data extraction techniques utilizes Optical Character Recognition (OCR), machine readings, text summarization, sentiment analysis, intent detection, Named Entity Recognition (NER), and Natural Language Processing (NLP).

15. The computer-implemented method as claimed in claim 1, wherein the plurality of data sources includes goods and/or services data, scraped data, market research, short-term memory data, long-term memory data, automated information management services, and user uploads.

16. The computer-implemented method as claimed in claim 1, wherein the plurality of interfaces utilizes Application Programming Interfaces (APIs), data translation protocols, messaging formats, and object models to enable communication between the plurality of AI agents.

17. The computer-implemented method as claimed in claim 1, wherein the plurality of deliverables includes financial forecasting, dynamically generated and modifiable business plans, market research plans, operating plans, and expansion plans.

18. The computer-implemented method as claimed in claim 1, wherein the user-readable formats comprise a dashboard interface, spreadsheets, and rich text format.

19. The computer-implemented method as claimed in claim 1, further comprising translating data from one user-readable format to another user-readable format, of the plurality of user-readable formats.

20. The computer-implemented method as claimed in claim 1, further comprising adding predefined capabilities to the plurality of AI agents through custom-generated features coded in a compatible programming language.

21. A computer system for Artificial Intelligence (AI) based provision of management consulting, the computer system comprising:
a memory unit configured to store machine-readable instructions; and
a processor operably connected to the memory unit, the processor configured to execute the machine-readable instructions, that when executed, enable the processor to:
divide the provision of management consulting into a plurality of tasks, the plurality of tasks defined as a plurality of respective workflows,
assign a plurality of Artificial Intelligence (AI) agents to the plurality of tasks with each one of the plurality of tasks assigned at least one AI agent,
provide the plurality of AI agents with characteristic reference data obtained from a plurality of data sources,
provide a plurality of interfaces to the plurality of AI agents for enabling exchanges of data amongst the plurality of AI agents, and
generate a plurality of deliverables in a plurality of user-readable formats, the plurality of deliverables collectively constituting the management consulting.

22. The computer system as claimed in claim 21, wherein the processor is further enabled to add predefined capabilities to the plurality of AI agents through custom-generated features coded in a compatible programming language.

23. The computer system as claimed in claim 21, wherein the processor is further enabled to customize one or more of the plurality of AI by training the one or more of the plurality of AI agents using fine-tuning techniques to fine-tune the one or more AI agents.

24. The computer system as claimed in claim 22, wherein for fine-tuning the one or more AI agents, the processor is further enabled to:
identify an AI agent from the plurality of AI agents,
identify a logic model for implementation of an inner monologue,
implement the inner monologue to the identified AI agent, and
fine-tune the inner monologue by distilling step-by-step method with manual intervention, and using a custom generated code segment.

25. The computer system as claimed in claim 21, wherein the processor is further enabled to validate the plurality of deliverables using industry benchmark data as a reference.

26. The computer system as claimed in claim 25, wherein for validating the plurality of deliverables the processor is enabled to utilize metrics including Key Performance Indicators (KPIs), benchmarking, regression analysis, gap analysis, and requirements traceability matrices.

27. The computer system as claimed in claim 25, wherein for validating the plurality of deliverables the processor is further enabled to receive user feedback through surveys, query responses, and explicit ratings.

28. The computer system as claimed in claim 25, wherein the processor is further enabled to modify one or more of the plurality of tasks, the plurality of AI agents, and the characteristic reference data provided to the plurality of AI agents following failure of the validation of the plurality of deliverables.
